(19) United States
(12) Patent Application Publication
(10) Pub. No.: US 2009/0044868 A1
(43) Pub. Date: Feb. 19, 2009

(54) Steam trap with capillary action based blocking arrangement

(76) Inventor: Ying Chuan Chiang, Taichung (TW)

Correspondence Address: SAM CHEN, 7F-1, 293, ROOSEVELT ROAD, SEC 3, TAIPEI, TW

(21) Appl. No.: 11/838,722

(22) Filed: Aug. 14, 2007

(51) Int. Cl. F16T 1/16

(52) U.S. Cl. 137/183

(57) ABSTRACT

A steam trap is provided to remove condensed water from a steam pipe having an end to which the strap is connected. In one embodiment, the trap includes a hollow body having an inlet adapted to secure to the pipe end and an outlet, the body comprising a staged internal space; a blocking member secured in the space and comprising a central projection on either surface and a plurality of apertures around the projections; and an abutment member in the rear of the blocking member. Condensate is adapted to pass the apertures while the steam is substantially blocked by the apertures due to capillary action.

### BACKGROUND OF THE INVENTION

1. Field of Invention

The invention relates to pipe fitting and more particularly to a steam trap having one or more blocking members which are adapted to block steam from passing a drain path due to capillary action.

2. Description of Related Art

Conventionally, steam traps are used to remove water and gases from a steam line while preventing the escape of live steam. And if, for example, the condensate is not removed, it will accumulate at low spots and present flow impediments and other inefficiencies.

A conventional orifice-type steam trap is shown in FIG. 4 and comprises a cylindrical housing 80 having an inlet 81 at one end and an outlet 82 at the other end. Within the housing 80 there are provided a narrow fluid path 83, an enlarged first space 84 adjacent the inlet 81, and an enlarged second space 85 adjacent the outlet 82. That is, the inner space of the housing 80 has a shoulder cross-section. Within the second space 85 there are mounted two funnel-like first members 86 and a funnel-like second member 87 fitted together. Either first member (e.g., the front first member 86) has a truncated conic head 88 and a narrow fluid path 83 through its center. The front first member 86 has its head 88 projecting into the first space 84. A cavity (e.g., the front cavity 89) is formed between the front first member 86 and the intermediate first member 86 and another cavity (not numbered) is formed between the intermediate first member 86 and the rear second member 87 respectively. The second member 87 has a rearward extending fastening portion and a narrow fluid path 91 through its center. By utilizing this staged arrangement, it is possible of without losing steam from the steam trap. Moreover, part replacement is made easy.

A Y-strainer fitting 92 is provided and has a first end secured to the inlet 81, a second end secured to a live steam line (not numbered), and an inclined housing 93. Within the housing 93, there are provided a cylindrical filter 94 having a screen 95 with a plurality of very small apertures 96 thereon. A plug 97 is threadedly secured to a third end of the Y-strainer fitting 92. The filter 94 is adapted to separate particulate matter and also provide a collection locus for water droplets.

The conventional orifice-type steam traps are widely employed in high, intermediate, and low pressure steam lines as well as heat exchangers.

However, the well known steam trap is only suitable to steam lines having a small amount of condensate to be removed. Thus, continuing improvements in the exploitation of steam trap are constantly being sought.

### SUMMARY OF THE INVENTION

It is therefore one object of the invention to provide a steam trap for removing condensed water from a steam pipe having an end to which the strap is connected, comprising a hollow body having an inlet adapted to secure to the pipe end and an outlet, the body comprising a staged internal space; one or more blocking members secured in the space wherein each blocking member comprises a central projection on either surface and a plurality of apertures around the projections; and an abutment member in the rear of the one or more blocking members. Condensate water is adapted to pass the apertures while the steam is substantially blocked by the apertures due to capillary action.

The above and other objects, features and advantages of the invention will become apparent from the following detailed description taken with the accompanying drawings.

### BRIEF DESCRIPTION OF THE DRAWINGS

FIG. 1 is a sectional view of a first preferred embodiment of steam trap according to the invention;

FIG. 2 is an exploded perspective view of the steam trap;

FIG. 3 is a sectional view of a second preferred embodiment of steam trap according to the invention; and

FIG. 4 is a sectional view of a conventional orifice-type steam trap.

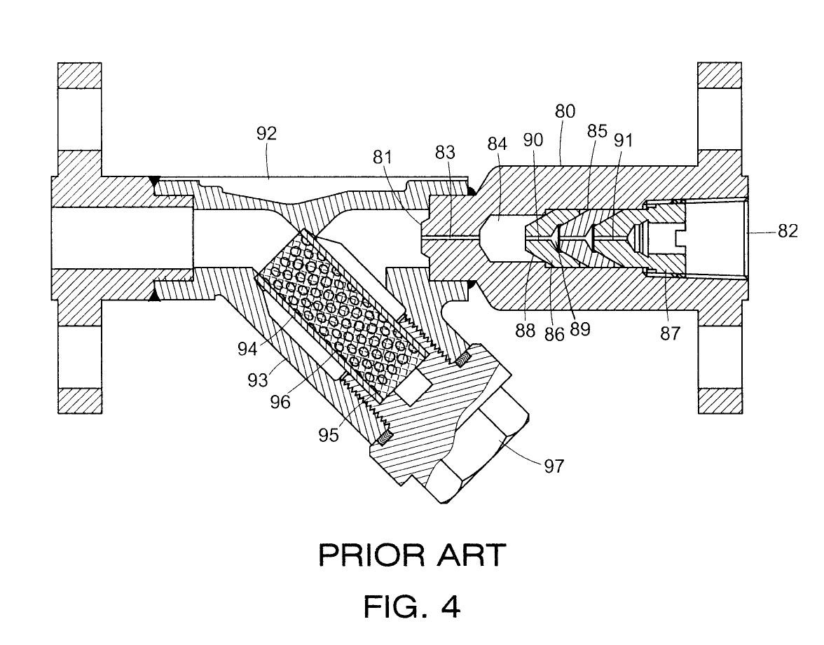

### DETAILED DESCRIPTION OF THE INVENTION

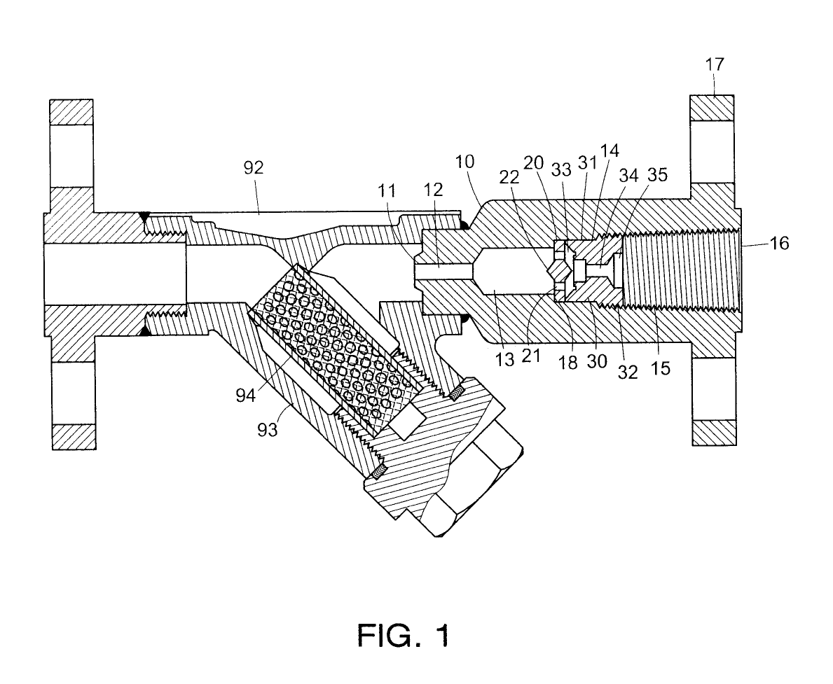

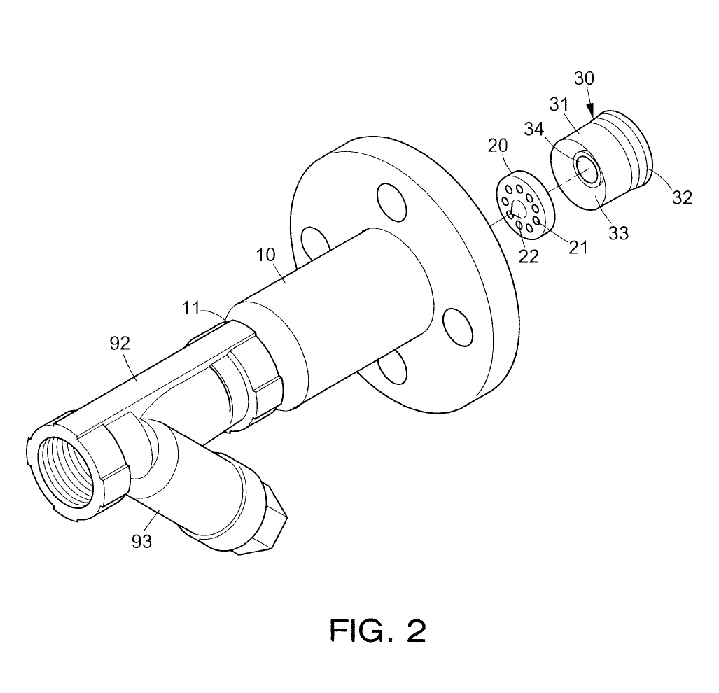

Referring to FIGS. 1 and 2, a steam trap in accordance with a first preferred embodiment of the invention comprises a cylindrical housing 10, a blocking member 20 in the housing 10, and an abutment member 30 in the housing 10. Each component is discussed in detail below.

Inner space of the housing 10 has a staged cross-section and is increased in size from a front position adjacent an inlet 11 to an outlet 16. An annular flange 17 is formed around the outlet 16 and is adapted to secure to a drain (not shown). The inner space of the housing 10 is provided with a first space 13 adjacent the inlet 11, and an enlarged second space 14 terminated at the outlet 16. A narrow fluid path 12 is formed in communication with the inlet 11 and the first space 13 at its both ends. A shoulder 18 is formed between the first and second spaces 13 and 14. Inner threads 15 are formed on a portion of the second space 14 terminating at the outlet 16.

A prior Y-strainer fitting 92 is provided and has a first end secured to the inlet 11, a second end secured to a steam line (not numbered), and an inclined housing 93. Within the housing 93, there is provided a cylindrical filter 94 which is adapted to separate particulate matter and also provide a collection locus for water droplets as known in the art. Note that the provision of the filter 94 is optional.

The disk-shaped blocking member 20 is urged against the shoulder 18 by the abutment member 30. The blocking member 20 comprises a central projection 22 on either surface and a plurality of apertures 21 around the projections 22.

The hollow cylindrical abutment member 30 comprises a front section 31 urging against the peripheral edge of the blocking member 20, a front recess (not numbered) together with the blocking member 20 for defining a space 33 therebetween, a rear section 32 having outer threads to be secured to the inner threads 15, a drain path 34 through its center, and a rear hexagonal cavity 35 such that a person may use a hex key to fasten or unfasten the abutment member 30 by engaging the cavity 35 and turning same.

In operation, steam carried from a boiler (not shown) passes a live steam line (not shown) and enters the steam trap through the inlet 12. The steam is compressed when passing the narrow inlet 12. Thus, condensate is formed. Then the steam and the condensate pass the enlarged first space 13. At the same time, expansion occurs and pressure is dropped accordingly. As a result, the condensate evaporates again to change into steam. Next, turbulence occurs for increasing flow friction when the steam contacts the front projection 22. Next, the condensate passes the apertures 21, the large space 33, and the narrow drain path 34 sequentially in which steam compression and evaporation occur. As an end, water which condenses from the steam is continuously removed from the steam trap to the external through the drain path 34. A specific gravity of steam is 0.001 which is much small than that of water. Capillary action occurring on the mouths of the apertures 21 can block steam from passing the apertures 21 into the space 33. By utilizing this, it is possible of without losing steam from the steam trap and removing as much water as possible.

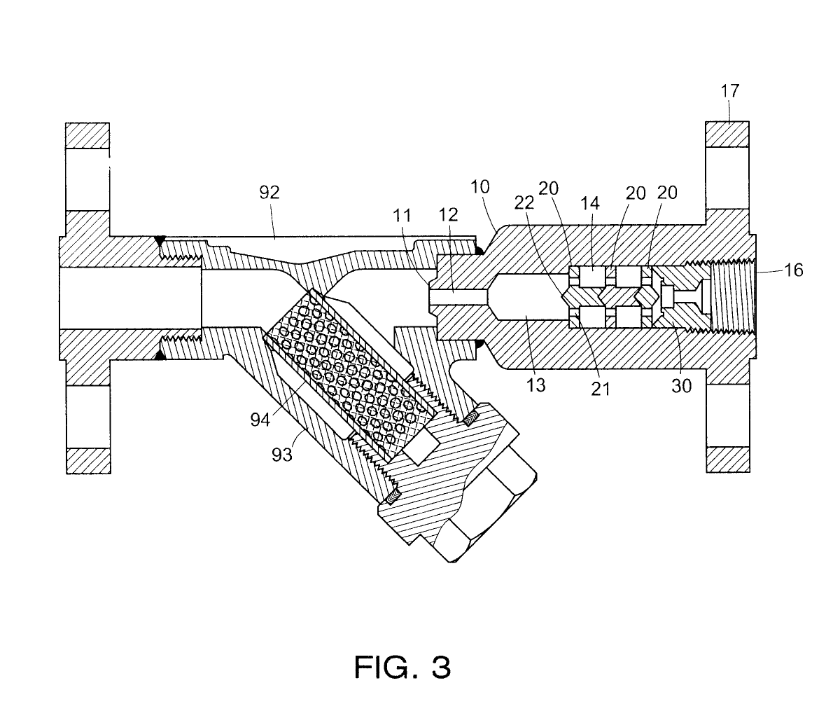

Referring to FIG. 3, a steam trap in accordance with a second preferred embodiment of the invention is shown. The second embodiment is identical to the first embodiment, except that inner threads (not numbered) of the housing 10 is short in length so as to provide more space to accommodate two additional second blocking members 20 which are substantially constructed the same as that of the blocking member 20 shown in the first embodiment. These three blocking members 20 are fitted together between the shoulder (not numbered) in the housing 10 and the abutment member 30. The second embodiment can increase the water removal performance of the steam trap.

The invention has the following advantages. More water is removed per unit time. Further, there are no moving components and thus components do not tend to malfunction. Furthermore, heat loss is greatly reduced. In addition, water hammering is eliminated.

While the invention herein disclosed has been described by means of specific embodiments, numerous modifications and variations could be made thereto by those skilled in the art without departing from the scope and spirit of the invention set forth in the claims.

What is claimed is:

1. A steam trap for removing condensed water from a steam pipe having an end to which the strap is connected, comprising:
a hollow body having an inlet adapted to secure to the end of the pipe and an outlet adapted to secure to a drain, the body comprising an internal space having a first stage and a second stage terminating at the outlet, and a fluid path in communication with the first stage and the inlet;
a blocking member at a shoulder between the first stage and the second stage, the blocking member comprising a central projection on either surface and a plurality of apertures around the projections; and
an abutment member disposed in the second stage and comprising a front section urged against a peripheral edge of the blocking member, a front recess, an axial drain path, and a rear section secured to the second stage and having a cavity on a rear end,
wherein steam conveying from the steam pipe enters the first stage through the inlet and the fluid path to impinge a front one of the projections such that water which condenses from the steam is adapted to pass the apertures and the drain path prior to entering the drain, and the steam is substantially blocked by the apertures.

2. The steam trap of claim 1, wherein the cavity is hexagonal.

3. A steam trap for removing condensed water from a steam pipe having an end to which the strap is connected, comprising:
a hollow body having an inlet adapted to secure to the end of the pipe and an outlet adapted to secure to a drain, the body comprising an internal space having a first stage and a second stage terminating at the outlet, and a fluid path in communication with the first stage and the inlet;
a plurality of blocking members secured together in the second stage wherein the front blocking member is disposed at a shoulder between the first stage and the second stage and each blocking member comprises a central projection on either surface and a plurality of apertures around the projections; and
an abutment member disposed in the second stage and comprising a front section urged against a peripheral edge of the rear blocking member, a front recess, an axial drain path, and a rear section secured to the second stage and having a cavity on a rear end,
wherein steam conveying from the steam pipe enters the first stage through the inlet and the fluid path to impinge a front one of the projections of the front blocking member such that water which condenses from the steam is adapted to pass the apertures and the drain path prior to entering the drain, and the steam is substantially blocked by the apertures.

4. The steam trap of claim 3, wherein the cavity is hexagonal.
